(19) United States
(12) Patent Application Publication
(10) Pub. No.: US 2021/0290482 A1
(43) Pub. Date: Sep. 23, 2021

(54) Wearable Focal Vibration Device and Methods of Use

(71) Applicant: The Board of Regents of the University of Oklahoma, Oklahoma City, OK (US)

(72) Inventors: Hongwu Wang, Edmond, OK (US); Mustafa Ghazi, Norman, OK (US); Josiah R. Rippetoe, Oklahoma City, OK (US); Madeleine Foote, Oklahoma City, OK (US); Sarah C. Brown, Yukon, OK (US)

(73) Assignee: The Board of Regents of the University of Oklahoma, Oklahoma City, OK (US)

(21) Appl. No.: 17/206,016

(22) Filed: Mar. 18, 2021

Related U.S. Application Data
(60) Provisional application No. 62/991,562, filed on Mar. 18, 2020.

(51) Int. Cl. A61H 23/02

(52) U.S. Cl. CPC A61H 23/02; A61H 23/0263; A61H 2201/123; A61H 2201/501; A61H 2201/1652; A61H 2201/1654; A61H 2201/5097; A61H 2201/5058

(57) ABSTRACT

A wearable focal vibration device for providing vibration therapy to a patient includes a control module, a vibration module and a vibration sensor. The vibration module is configured to output a vibration in response to a command signal from the control module. The vibration sensor is configured to output a signal to the control module representative of the vibration measured by the vibration sensor. The wearable focal vibration device may also include a harness for attaching the wearable focal vibration device to the patient. The harness can include a compression mechanism and a compression sensor for ensuring that the focal vibration device is sufficiently and consistently secured to the patient.

### RELATED APPLICATIONS

This application claims the benefit of U.S. Provisional Patent Application Ser. No. 62/991,562 filed Mar. 18, 2020 entitled, “Wearable Focal Vibration Device and Methods for Use,” the disclosure of which is herein incorporated by reference as if fully set forth herein.

### BACKGROUND

Over the last decade, the uses of applied vibration in physical and rehabilitation medicine have been extensively investigated, including neurorehabilitation, a field where significant progress has been made in understanding both pathophysiology of the diseases and the influence of vibrational energy on the nervous system. Focal vibration (FV), a technique in which targeted vibration is applied to specific muscles or muscle groups, represents an innovative strategy to enhance balance and motor control and is applicable across different neurological diseases. FV activates peripheral mechanoreceptors, leading to both short-term and long-term dynamic changes within somatosensory and motor systems, such that repeated applications may promote neuroplasticity with subsequent improvement in motor behavior. Clinical and research results have shown satisfactory outcome of focal vibration as a useful tool in neurorehabilitation.

However, many aspects of commercially available FV devices are unsatisfactory. For example, these devices are operated through an open loop control, meaning that they may not deliver accurate vibrations. Another issue with these devices is that they lack a way to monitor or track the usage of the vibrational therapy. Therapists thus lack information which would be useful in ensuring that their patients are performing the correct dosage and length of treatment of FV. This causes a disconnection between the therapist and the patient when using these devices. Among the shortcomings of currently available devices reported by users are (i) lack of accurate, repeatable vibration delivery, (ii) insufficient dosage feedback for user, (iii) no usage or dosage tracking and monitoring for therapist and patient, (iv) discomfort, (v) difficulty donning and removing the device, (vi) inadequate control of dosage, and, (vii) difficulty in performing other tasks while wearing and using. Thus, improvements in FV technology are needed to address the shortcomings of currently used FV devices.

### BRIEF DESCRIPTION OF THE DRAWINGS

FIG. 1 shows a focal vibration device secured to a patient and connected through a network to a clinician's computer.

FIG. 2 shows a functional block diagram of the focal vibration device.

FIG. 3 depicts the orientation of an embodiment of the vibration module on a target body part of the patient.

FIG. 4 depicts one embodiment of holding the vibration module against the target body part of the patient using a harness that includes an air bladder.

FIG. 5 shows an embodiment of a sleeve designed to support the focal vibration device 100 on the patient.

FIG. 6 provides a process flow chart for a method of using the focal vibration device to provide a treatment protocol to a patient.

### DETAILED DESCRIPTION

The present disclosure is directed to, in at least one embodiment, a wearable focal vibration device that can be worn at different locations of muscles and muscle groups and which provides precision vibration therapy thereto. The wearable focal vibration device, also referred to herein as a “FoVi” device, can adjust the intensity settings of vibration motors and can provide direct feedback. The control and feedback system may be accomplished through the use of a mobile device application to provide patients real time feedback on the usage of the vibration therapy. A web portal also enables a therapist or healthcare professional to monitor and track the therapeutic usage of the device, as well as allows them to remotely adjust the vibration dosage and duration based on the rehabilitation progress of patients. The device of the present disclosure may be designed to be provide focused vibrational therapy to a “target body part” which could benefit from such therapy, such as a patient's leg, arm, knee, elbow, shoulder, wrist, foot, ankle, calf, thigh, upper arm (e.g., tricep and/or bicep), forearm, chest, torso, back, hip, waist, neck, and/or shoulder blade.

Before further describing various embodiments of the apparatus and methods of the present disclosure in more detail by way of exemplary description, examples, and results, it is to be understood that the embodiments of the present disclosure are not limited in application to the details of apparatus and methods as set forth in the following description. The embodiments of the apparatus and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus and methods of the present disclosure have been described in terms of particular embodiments, it will be apparent to those of skill in the art that variations may be applied to the apparatus, compositions and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure.

As used herein any reference to “we” as a pronoun herein refers generally to laboratory personnel or other contributors who assisted in the laboratory procedures and data collection and is not intended to represent an inventorship role by said laboratory personnel or other contributors in any subject matter disclosed herein.

Returning now to the various embodiments disclosed herein, several non-limiting examples will be described and discussed. As previously noted, a significant deficiency of current vibration devices is the lack of feedback control. Prior art devices deliver vibration in an open loop fashion and thus lack the ability to deliver vibration accurately. Without feedback, vibration delivery also lacks repeatability over time or between patients. Clinicians therefore cannot directly monitor a patient's usage or the effectiveness of the currently available devices, which frustrates efforts to intelligently adjust dosage and treatment protocols.

To overcome these and other deficiencies in the prior art, the presently disclosed focal vibration device 100 uses real-time feedback by measuring the vibration actually delivered to the patient, and adjusting for variations in the environment, body type, muscle reaction, and other factors specific to the subject using the device. The feedback obtained by the focal vibration device 100 This capacity for feedback control is valuable because vibration characteristics of the focal vibration device 100 change after the focal vibration device 100 has been applied to the body due to the damping effect of the body on the vibrations output by the focal vibration device 100. Furthermore, different body parts and different individuals have differing effects on the vibration characteristics of the device. With feedback control, the focal vibration device 100 device can ensure that a known and repeatable amount of vibration is actually delivered to a target location on the patient's body in accordance with the prescribed protocol for rehabilitation and/or treatment.

In prior art focal vibration devices, the tightness of the device varies depending on how tightly each individual user or therapist secures it to the patient's body. This variability introduces great inconsistency in how tightly the device is applied to the body and thus inconsistency in the amount of vibration applied to the body. This reduces consistency in how the vibration therapy is delivered between treatments in a single patient, or in treatments among different patients. To remove the variability in vibration delivered to the target location caused by differences in how the focal vibration device 100 is worn by the subject, the focal vibration device 100 can be secured to the subject's body at a specified tightness, thereby enabling the focal vibration device 100 to deliver consistent and repeatable degree of vibration. The amount of vibration delivered by the focal vibration device 100 can change depending on how tightly the focal vibration device 100 is pressed against the body.

In various embodiments, the focal vibration device 100 of the present disclosure can be controlled through the use of a remote, a control box, or a phone app. For the control box, the focal vibration device 100 can be wired, while for the remote and phone app, the focal vibration device 100 can be wireless. For the wired approach, the focal vibration device 100 has a central control box that is attached to the vibration motors via wires across the body. Control settings, i.e. on/off switch and intensity settings, for each motor are directly on the control box. The remote can have control settings for each motor and can be configured to change the settings via various wireless interfaces, such as but not limited to, infrared (IR) light, 433 MHz radio, 900 MHz radio, or 2.4 GHz radio. The phone app wirelessly controls the motors via Bluetooth connection.

The focal vibration device 100 of the present disclosure has versatility and can be used as both a rehabilitative and an assistive device to deliver precision vibration therapy. Clinically, focal vibration can be used to increase range of motion, decrease pain, and decrease spasticity. Focal vibration can also be used as an assistive device to aid in postural control and cue reminders through proprioceptive input which increases balance and stability and decreases fall risks. A therapist can monitor the usage and remotely adjust dosage (e.g., duration, intensity, and/or frequency) of the vibration provided by the focal vibration device 100 device to a user. The focal vibration device 100 is designed to be worn during a patient's normal activities. The focal vibration device 100 can also help decrease pain and increase motion in a patient-friendly manner. Both patients and clinicians can monitor and adjust the vibration through direct feedback control. Prior art devices are not accurate in their delivery of vibrations to target muscles, whereas the focal vibration device 100 delivers accurate and precise vibration doses through the use of a closed loop control system. The focal vibration device 100 device can be used in the home or in clinical or community settings. In various embodiments, the focal vibration device 100 device may be used in the rehabilitation of stroke subjects, for improving the gait and enhancing the mobility of patients with diabetic peripheral neuropathy (DPN) or multiple sclerosis.

Thus, the focal vibration device 100 is a wearable vibration device capable of delivering precise localized vibration, with high repeatability, by using stimulation measurement sensor(s) and a feedback control algorithm to make sure the vibration is delivered accurately. The focal vibration device 100 can be controlled by an on/off switch on the device, or via a mobile device app, or a remote controller for those without a mobile device such as a smartphone. The focal vibration device 100 not only provides vibration therapy, but also tracks patient compliance and allows therapists to remotely monitor the vibration therapy usage, to remind patients using the device, and to allow remote adjustability of the vibration dosage based on rehabilitation progress.

The present disclosure will now be discussed in terms of several specific, non-limiting, examples and embodiments. The examples described below, which include particular embodiments, will serve to illustrate the practice of the present disclosure, it being understood that the particulars shown are by way of example and for purposes of illustrative discussion of particular embodiments and are presented in the cause of providing what is believed to be a useful and readily understood description of procedures as well as of the principles and conceptual aspects of the present disclosure.

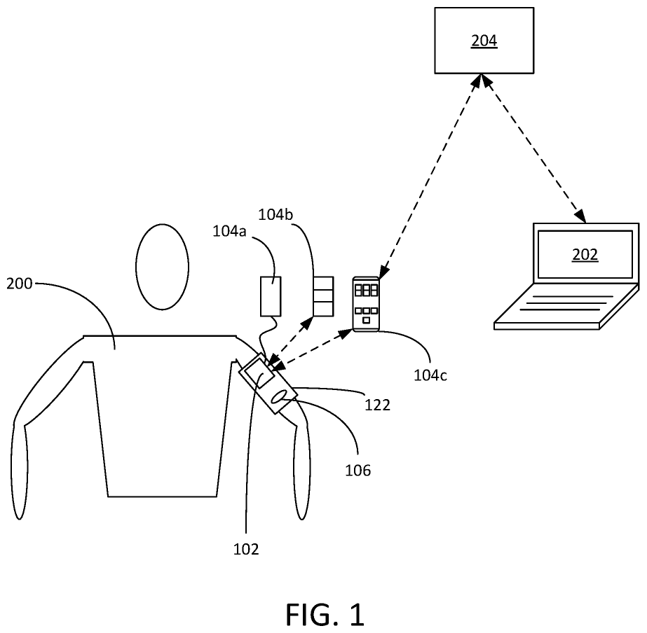

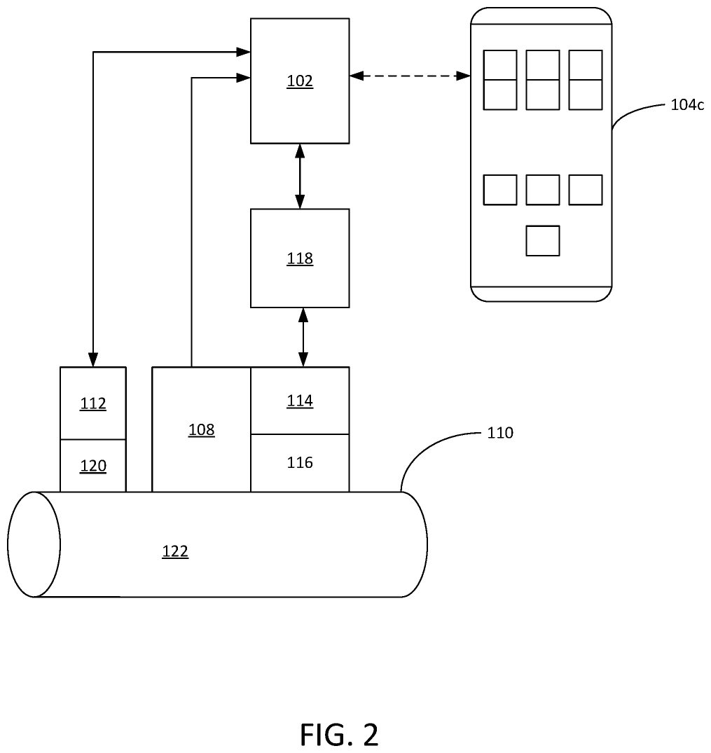

Turning to FIGS. 1 and 2, shown therein is an embodiment of the focal vibration device 100 worn by a patient 200. The focal vibration device 100 generally includes a control module 102, a controller 104, a vibration module 106, a vibration sensor 108, an adjustable harness 110, and a compression sensor 112. In some embodiments, the control module 102 is included within the harness 110, while in other embodiments the control module 102 is contained within a separate case (not shown) and connected to the harness 110 with a wired or wireless connection. In exemplary embodiments, the control module 102 is powered by a rechargeable battery. In other embodiments, the control module 102 is configured to be plugged into a power supply.

As illustrated in FIG. 1, the controller 104 can be a hard-wired remote (104a), a dedicated wireless remote (104b), or a mobile computing device (104c), such as a conventional smart phone or tablet. For embodiments in which the focal vibration device 100 is configured to connection to a mobile computing device 104c, the mobile computing device 104c is provided with an application (“app”) for interfacing, controlling, logging, and communicating information about the operation of the focal vibration device 100 to a remote clinician computer 202 through a network 204. It will be appreciated that the network 204 can be a local network or a public network, such as the internet. In some embodiments, the focal vibration device 100 is controlled with a user interface on the controller 104 which controls various components of the focal vibration device 100 through algorithm(s) for quantitative computation of the stimulation and algorithm(s) for quantitative computation of the compression applied by the harness 110. The control module 102 can include one or more wireless communication chipsets for managing a wireless data transfer with the controller 104b or 104c.

The vibration module 106 generates vibration through physical movement against the body. The vibration module 106 may include a motor 114 and mass 116 that are configured as an Eccentric Rotating Mass (ERM) vibration motor and/or a Linear Resonant Actuator (LRA) vibration motor. The focal vibration device 100 can include a motor driver 118 that is integrated into the control module 102, or provided as a separate electrical component. The motor driver 118 produces an output signal that controls the operation of the motor 114 in response to a signal from the control module 102. Thus, in response to a command signal from the control module 102, the vibration module 106 produces a vibrational response at a nominal frequency and energy, which is conducted to the patient 200 through the harness 110. In many embodiments, the vibration module 106 includes an integrated form of the vibration sensor 108.

The vibration sensor 108 measures the actual amount of vibration delivered from the vibration module 106 to the patient 200. This is used for monitoring and feedback control. Stimulation is measured in free activation mode as well as constrained activation mode. The free activation mode is the state in which vibration module 106 is not in contact with the body of the patient 200 (free vibration). The constrained activation mode is the state in which the vibration module 106 is in contact with the body of the patient 200 (constrained vibration). The sensor technology may include, but is not limited to, accelerometers, gyroscopes, magnetometers, optical encoders, magnetic encoders, potentiometers, analog-to-digital converters (ADCs), current sensors, photodiodes, phototransistors, photoresistors, cameras, magnetic field sensors, audible sound measurement, ultrasound measurement, Linear Variable Differential Transformers (LVDT), strain gages, load cells, pressure sensors, capacitance meters, and/or temperature sensors. The vibration sensor 108 produces an output signal to the control module 102, which can then make adjustments to the operation of the vibration module 106.

The harness 110 includes a compression mechanism 120 that is configured to press or tighten the vibration module 106 against the target area of the patient's body. The compression sensor 112 provides an indication of how tightly the harness 110 is holding the vibration module 106 against the patient 200. Measuring how tightly the vibration module 106 is held against the patient 200 allows the focal vibration device 100 to compensate for variability caused by inconsistent attachment of the focal vibration device 100 to the patient 200. The compression mechanism 120 may include, but is not limited to, inflatable bladders, straps, cords, bands, pumps, motors, servos, solenoids, ratchets, gears, pulleys, wheels, springs, buckles, clips, clasps, or hooks.

The compression sensor 112 may be built into the compression mechanism 120, or it may be external and removable, such that it is attached while adjusting the tightness and then removed when the desired tightness is achieved. The sensor technology may include, but is not limited to, springs, dial indicators, magnets, potentiometers, analog-to-digital converters (ADCs), current sensors, photodiodes, phototransistors, photoresistors, cameras, Linear Variable Differential Transformers LVDTs, strain gages, load cells, pressure sensors, or capacitance meters. In some embodiments, the compression mechanism 120 includes a motorized inflator that can be configured to inflate a bladder 122 to a known pressure, which is reflective of the amount of compression applied by the pneumatic harness 110 to the patient 200.

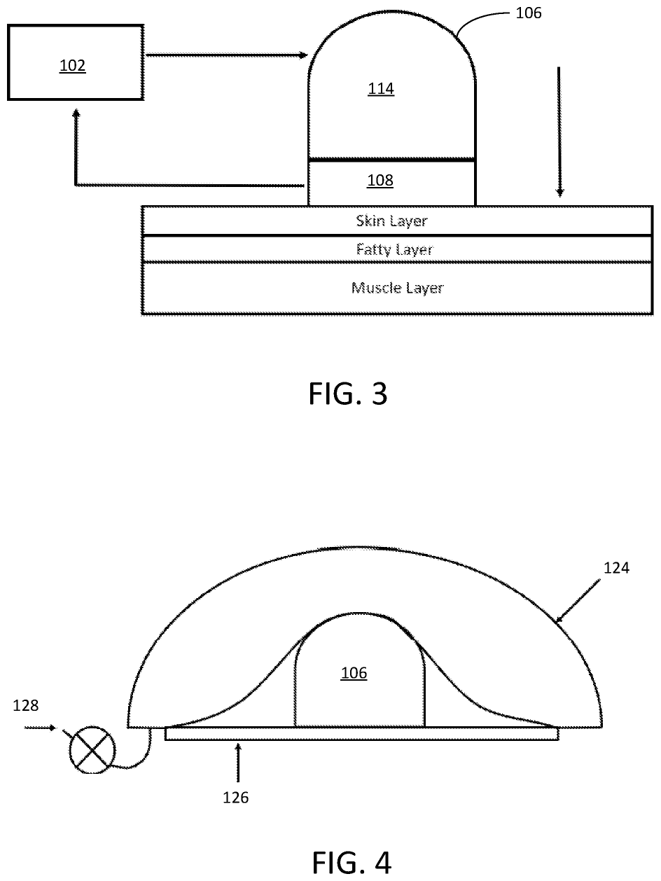

FIG. 3 shows an illustration of an embodiment in which the vibration module 106 is positioned upon a body surface. The vibration module 106 includes the motor 114 and the vibration sensor 108 to provide real-time feedback control. The control module 102 drives the vibration motor 114 to cause stimulation of tissues beneath the motor 114, and the vibration sensor 108 detects the level of vibration and provides feedback to the control module 102, which can then adjust the operation of the vibration motor 114 to increase or decrease various parameters of the vibration motor 114 such as frequency, intensity, and duration of treatment.

The control module 102 has several functions, including (1) driving the vibration module 106 based on desired stimulation patterns input from the user interface, and (2) using signals from the vibration sensor 108 for real-time feedback control of the vibration module 106 for accurate and robust delivery of the stimulation. This ensures that the desired stimulation is delivered despite changes or variability in the operational environment. The control module 102 also uses signals from the compression sensor 112 for feedback control of the compression mechanism 120 to maintain the desired level of tightness. The control module 102 optionally includes an onboard memory that can log usage data.

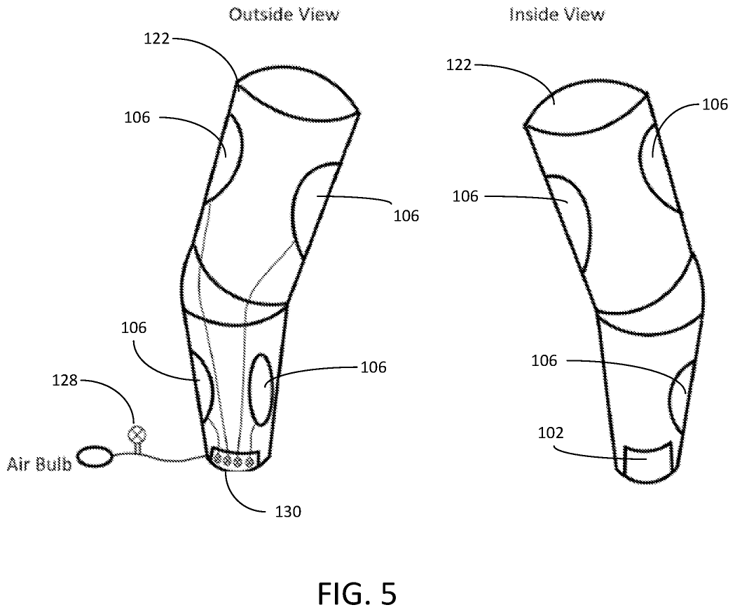

Turning to FIGS. 4-5, the harness 110 houses the components of the focal vibration device 100 and functions to secure the various components about the body of the patient 200. In some embodiments, as depicted in FIG. 4, the harness 110 includes the air bladder 124, which is configured to press the vibration module 106 into the body of the patient 200. An intermediate pad 126 may be used between the vibration module 106 and the patient 200 for comfort. A manual inflation valve 128 can be used to inflate and deflate the bladder 200.

In another embodiment, the harness 110 includes an adjustable sleeve 122 with casings and pockets to house all of the components of the focal vibration device 100. The harness 100 may include guide markings to help for accurate placement of the vibration module 106 upon specific anatomical locations. The adjustable sleeve 122 increases comfort and user friendliness. The adjustable sleeve 122 includes one or more vibration modules 106 placed in specific locations to provide vibration therapy to each individual muscle which is desired to be stimulated. In one non-limiting embodiment, each vibration module 106 includes a vibration motor 114 placed in between an air bladder 124 as the compression mechanism 120 and the intermediate rubber pad 126, as shown in FIG. 3. The intermediate pad 126 distributes the load from the vibration module 106 more uniformly and provides added comfort for the patient 200. When the air bladder 124 is deflated, the patient 200 experiences the maximum vibrational forces from the vibration module 106. When the air bladder 200 is inflated, it provides a damping effect to the vibrations of the motor 114. The patient can control the amount of air pressure in each vibration module 106 independently with a valve manifold 130, thereby providing each muscle with the appropriate vibrational strength. The patient 200 can also adjust each the motor speed of each vibration module 106 independently via the user interface on the controller 104, effectively varying the frequency. By allowing both the vibrational strength and frequency to be independently adjusted for each vibration module 106, the patient will be able to administer the appropriate dosage of vibration therapy in a controlled manner.

The sleeve 122 also aids the patient 200 in correct placement of the focal vibration device 100. This ensures that vibration will be applied to the designated muscles prescribed by the therapist or clinician. In non-limiting embodiments, the sleeve 122 (or “body interface”) may be constructed from an individualized mold which is specifically molded according to the shape of a particular patient's extremity or body part (e.g., leg, arm, knee, elbow, shoulder, wrist, foot, ankle, calf, thigh, upper arm, tricep, bicep, forearm, chest, torso, back, hip, waist, neck, shoulder blade, etc.). The sleeve 122 may include, for example, 4-10 vibration modules 106 to deliver vibratory stimuli to target muscles. Each vibration module 106 will deliver vibration with a frequency between 60-300 Hz, and amplitude between 0.1-10 mm, and activation and deactivation of each vibration motor 114 can be controlled individually. Intensity of vibration and other parameters is adjustable. Arm and/or leg movements are trackable via the built-in accelerometer-based vibration sensors 108. Therapists can remotely monitor the patient 200 through the network 204 and remotely make adjustments to the operation of the focal vibration device 100. The clinician can also remotely log the usage of the system and assess quality of limb movement.

A key aspect of the presently disclosed focal vibration device 100 is the capability of adjusting the intensity of the vibration motors 114. In one non-limiting embodiment, the focal vibration device 100 may have four intensity settings: off, low, medium, and high, or may comprise means for adjusting the intensity across a continuous range. The focal vibration device 100 may be configured with multiple (e.g., three) vibration motors 114 each supplied with its own vibration sensor 108 (e.g., STMicroelectronics© LSM9DS1 accelerometer), a control module 102 (e.g., PJRC Teensy® 3.2), a Bluetooth module (e.g., Adafruit Bluefruit LE UART Friend), a motor driver 118 (e.g., Pololu® TB6612FNG), a rechargeable battery (e.g., Adafruit® 1200 mAh Lithium Ion Battery), and a battery charger (e.g., Adafruit® LiPoly USB charger).

The controller 104 (e.g., smartphone) app enables the patient 200 to have direct control of each motor 114, i.e., to be able to turn a motor 114 off or turn it to a particular setting. The patient 200 can independently select either a low, medium, or high intensity setting (or other setting as enabled in the focal vibration device 100) for each vibration motor 100. The Bluetooth module allows for direct communication between the phone app and the control module 102 within the focal vibration device 100. The control module 102 controls the motor driver 118 which then in turn manipulates the vibration motors 114. Each motor 114 has its own accelerometer-based vibration sensor 108 that reads the acceleration caused by the vibration for feedback control.

The power level of each battery (there may be a single battery to supply all motors or a dedicated for each motor) may be determined by an LED light on the motor, for example a red light for low battery power, and a green light for high battery power. The cell phone app displays the intensity level for each motor from the data received from the Bluetooth module via Bluetooth Low Energy (BLE), i.e. off, low intensity, medium intensity, and high intensity. The Bluetooth module receives the data from the microcontroller via a universal asynchronous receiver/transmitter (UART) and also transmits these data via BLE to the phone app for feedback control. As noted above, the control module 102 controls the motor drivers 108 which in turn activate the vibration motors 114, each of which is equipped with an accelerometer-based vibration sensor 108, which reads acceleration and vibration data from the vibration motor 108. These readings are sent back to the control module 102 via a data a data connection, such as a serial peripheral interface (SPI). In exemplary embodiments, the motors 114 are separated from the control module 102 and other electronics, and from each other to ensure that miniscule interference occurs between the motors 114 and the electronics and also between each motor 114 for greater feedback control.

The phone app displays the current status of intensity for each motor 114. When the patient 200 changes the intensity levels of the vibration motors 114, the information is sent from the app to the Bluetooth module via BLE. The data is then delivered to the control module 102 via UART which then activates the motor driver 118. The motor drivers 118 then alter the intensity levels of the vibration motors 114 to the specified intensity level. Acceleration readings are collected from the vibration sensor 108 on each vibration motor 114 and transferred to the control module 102 via SPI. The readings are then conveyed to the Bluetooth module via a UART and then are transmitted to the phone app via BLE. Finally, the phone app displays the updated status of the intensity levels of each motor 114. In one non-limiting embodiment, a smartphone app that can be used for controlling the focal vibration device 100 and for direct feedback is Nordic® nRF Toolbox mobile app. When the focal vibration device 100 is off, the display reads 0 g, where g is the acceleration of the device relative to gravity, which is the acceleration reading from the accelerometer. The following is displayed on the app for the low, medium, and high intensity settings, respectively: 2 g, 5 g, and 9 g, where the first setting is for low, second setting is for medium, and third setting is for high.

The focal vibration device 100 may find particular utility in assisting with upper limb rehabilitation following stroke. In one embodiment, the focal vibration device 100 can provide vibration-based muscle activation for upper limb function rehabilitation following a stroke or other event. It provides the patient 200 with an opportunity to apply the prescribed vibratory stimuli in-home and/or in community settings to improve their upper limb muscle strength and function. It allows the therapist to monitor treatment usage and patient performance and to adjust the treatment doses.

A significant problem seen in rehabilitating stroke patients is the lack of sustainable use of focal vibration therapy. The main reason for the unsustainability is the under-dosage of the interventions. Low patient compliance and participation exacerbates the problem because stroke recovery and rehabilitation often require multiple treatment sessions, each requiring a visit to the study site. The target population is the approximately 795,000 people in the United States who have had strokes. With its remote monitoring and adjustment capabilities, the focal vibration device 100 facilitates large-scale research on intervention dosage, patient compliance, changes in upper limb functional outcomes, cost effectiveness, and utilization in a logistically feasible and cost/time efficient manner.

The focal vibration device 100 features precise vibration stimulus delivered to target muscles by closed loop control, including adjustable intensity settings, direct user feedback through a mobile device app, and a web portal which enables a therapist to monitor and track the usage, and to remotely adjust the dosage based on rehabilitation progress. Various vibration parameters, such as frequency, amplitude, and duration can be modulated and adjusted remotely to improve upper limb function and performance for stroke patients.

In at least one non-limiting embodiment, the present disclosure is directed to a method of applying a focal vibration device to a body part of a user, comprising: securing the focal vibration device, for example as described above, to the body part of the user; causing the stimulation mechanism to apply a stimulation to the body part, tightening the stimulation mechanism against the body part via the tightening mechanism, measuring the stimulation via the stimulation measurement sensor, measuring a tightness via the tightness measuring sensor, and adjusting the stimulation mechanism and the tightening mechanism according to measurements received by the control module.

Also as shown above, in at least one non-limiting embodiment, the present disclosure is directed to a wearable apparatus for providing vibration therapy, comprising: (1) a flexible component configured to interface with a portion of a body of a user; (2) a plurality of electric-powered motors integrated within the flexible component, wherein the plurality of electric-powered motors are configured to provide a plurality of pulsations on different areas of the body of the user; (3) a first sensor, wherein the first sensor is configured to process feedback information from the plurality of electric-powered motors; (4) a component configured to adjust a proximity of the plurality of electric-powered motors within the flexible component to the portion of the body of the user; (5) a second sensor, wherein the second sensor is configured to process feedback information from the component configured to adjust the proximate of the plurality of electric-powered motors within the flexible component to the portion of the body of the user; (6) a control module, wherein the control module is configured to couple the apparatus to a nearby electronic device, wherein the control module is configured to electronically couple to the plurality of electric-powered motors; and (7) a user interface configured to electronically couple to the control module. The apparatus may comprise a wireless power source. The apparatus may further comprise a motor controlling component configured to (1) electronically couple to the control module and the plurality of electric-powered motors, (2) adjust the plurality of electric-powered motors; and (3) receive a feedback signal from the plurality of electrically-powered motors. The control module may be configured to transmit a plurality of communication signals comprising a plurality of programmed modes which are configured to adjust the plurality of pulsations provided by the plurality of the electrically-powered motors. The control module may be configured to process the feedback information carried on a communication signal to determine whether the feedback information carried on the communication signal matches one or more preconfigured settings, wherein when the feedback information carried on the communication signal matches one or more preconfigured settings, a motor controlling component is configured to transmit the feedback information carried on the communication signal to a vibration motor; and wherein when the feedback information carried on the communication signal does not match the one or more preconfigured settings, the motor controlling component is configured to refrain from transmitting the feedback information carried on the communication signal to the motor controlling component; and wherein, responsive to receiving the feedback information carried on the communication signal, the vibration motor is configured to adjust one or more parameters to match the feedback information carried on the communication signal.

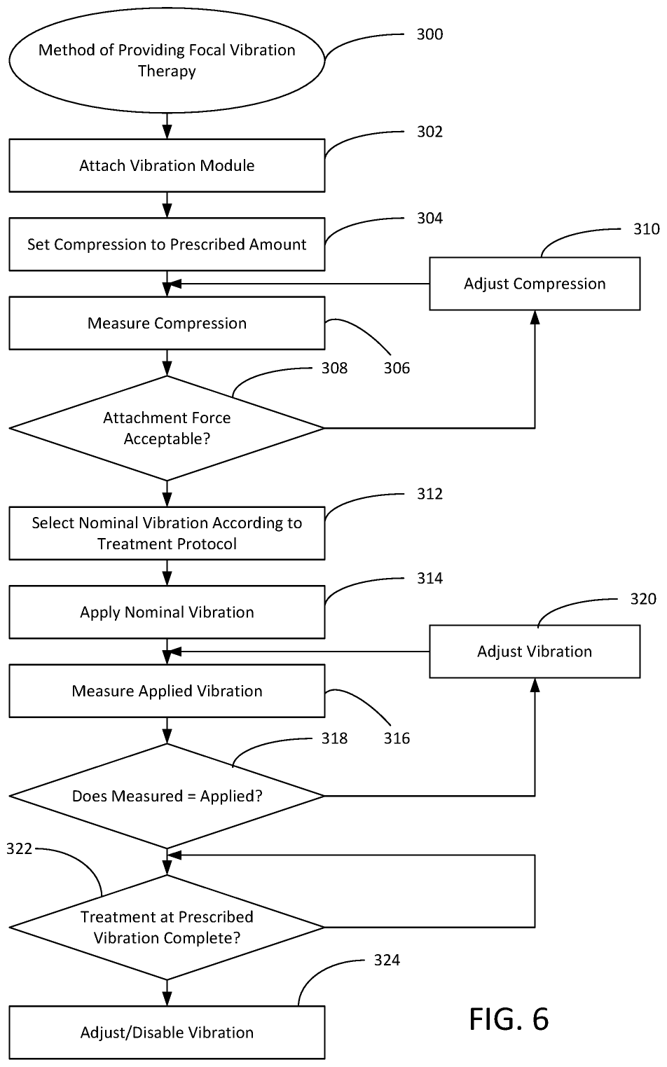

Turning to FIG. 6, shown therein is a flow chart for a method 300 of using the focal vibration device 100 to provide a focal vibration treatment to the patient 200 in accordance with a treatment protocol. At step 302, the focal vibration device 100 is secured to the patient 200 such that the vibration module 106 is properly located on a target body part. The step 302 of attaching the focal vibration device 100 to the patient may involve securing the sleeve 122 to the bicep of the patient 200, as depicted in FIG. 1.

Next at step 304, the focal vibration device 100 is tightened around the target body part of the patient 200. In step 304, the focal vibration device 100 can be tightened using the compression mechanism 120, such as the air bladder 124 or straps. At step 306, the focal vibration device 100 uses the compression sensor 112 to determine how tightly the focal vibration device 100 is attached to the patient 200. At step 208, the focal vibration device 100 determines if the appropriate compression or tightness has been applied by the focal vibration device 100 by comparing the current compression against a “design” or prescribed compression. Step 208 can be carried out automatically by the control module 102 based on data provided by the compression sensor 112, or manually by a clinician. If the compression is not correct, the process moves to step 310 and the compression is adjusted. The method 300 follows a loop through steps 306, 308 and 310 until the prescribed amount of tightness is obtained.

Once the focal vibration device 100 has been secured to the patient 200 with the prescribed level of tightness or compression, the method 300 moves to step 312, where a nominal level of stimulation is selected (e.g., frequency, intensity and duration). It will be appreciated that step 312 may take place before the focal vibration device 100 is attached to the patient 200. Once the nominal level of stimulation has been selected, the method 300 moves to step 314 where the focal vibration device 100 activates the vibration modules 106 according to the nominal parameters for the stimulation.

Next, at step 316, the characteristics of the vibration actually applied to the patient 200 are measured using the vibration sensor 108. This step may involve using an accelerometer-based vibration sensor, as described above. The method 300 then moves to step 318, where the measured vibration characteristics (e.g., frequency and/or intensity) are compared against the nominal, prescribed vibration characteristics. If the measured vibration characteristics do not match the prescribed, nominal vibration characteristics, the method 300 moves to step 320 and the control module 102 makes adjustment to the output of the vibration motors 114. The method 300 may loop through steps 316, 318 and 320 until the actual, measured vibration matches (within an acceptable margin) the prescribed vibration characteristics (e.g., frequency and/or intensity).

Once the vibrational characteristics have been tuned to match the prescribed vibrational characteristics, the method 300 moves to step 322, where a timer at the control module 102 determines whether the vibrational frequency has been applied for a period that matches the prescribed period under the treatment protocol. The method 300 continues to apply the prescribed vibrational therapy until the treatment protocol calls for the vibration to be changed or discontinued at step 324. If the protocol calls for the focal vibration device 100 to shift to a new output with different vibrational characteristics, the method 300 can return to step 312 where the control module 102 initiates the delivery of a new set of vibrational characteristics (e.g., frequency and/or intensity) for a prescribed duration. If, at step 322, the control module 102 determines that the treatment is complete, the control module 102 can turn off the vibration modules 106. It will be appreciated that method 300 may also include periodic checks of the compression (tightness) of the focal vibration device 100 and the vibrational output of the focal vibration device 100 by periodically returning to steps 306 and 316, respectively, during the treatment.

While the present disclosure has been described in connection with certain embodiments so that aspects thereof may be more fully understood and appreciated, it is not intended that the present disclosure be limited to these particular embodiments. On the contrary, it is intended that all alternatives, modifications and equivalents are included within the scope of the present disclosure. Thus the examples described above, which include particular embodiments, will serve to illustrate the practice of the present disclosure, it being understood that the particulars shown are by way of example and for purposes of illustrative discussion of particular embodiments only and are presented in the cause of providing what is believed to be the most useful and readily understood description of procedures as well as of the principles and conceptual aspects of the presently disclosed methods and compositions. Changes may be made in the structures of the various components described herein, or the methods described herein without departing from the spirit and scope of the present disclosure.

It is claimed:

1. A wearable focal vibration device for providing vibration therapy to a patient, the focal vibration device comprising:
a control module;
a vibration module configured to output a vibration in response to a command signal from the control module; and
a vibration sensor configured to output a signal to the control module representative of the vibration measured by the vibration sensor.

2. The wearable focal vibration device of claim 1, wherein the vibration module comprises:
an electric motor; and
a mass moved by the electric motor.

3. The wearable focal vibration device of claim 1, wherein the vibration module is selected from the types of vibration modules consisting of Eccentric Rotating Mass (ERM) vibration motors and Linear Resonant Actuator (LRA) vibration motors.

4. The wearable focal vibration device of claim 1, wherein the vibration sensor is selected from the group consisting of accelerometers, gyroscopes, magnetometers, optical encoders, magnetic encoders, potentiometers, analog-to-digital converters (ADCs), current sensors, photodiodes, phototransistors, photoresistors, cameras, magnetic field sensors, audible sound measuring devices, ultrasound measuring devices, Linear Variable Differential Transformers (LVDT), strain gages, load cells, pressure sensors, capacitance measuring devices, and temperature sensors.

5. The wearable focal vibration device of claim 1 further comprising a harness for attaching the focal vibration device to the patient.

6. The wearable focal vibration device of claim 5, wherein the harness comprises:
a compression mechanism; and
a compression sensor.

7. The wearable focal vibration device of claim 6, wherein the compression mechanism is selected from the group consisting of inflatable bladders, straps, cords, bands, pumps, motors, servos, solenoids, ratchets, gears, pulleys, wheels, springs, buckles, clips, clasps, and hooks.

8. The wearable focal vibration device of claim 6, wherein the compression sensor is selected from the group consisting of springs, dial indicators, magnets, potentiometers, analog-to-digital converters (ADCs), current sensors, photodiodes, phototransistors, photoresistors, cameras, Linear Variable Differential Transformers (LVDT), strain gages, load cells, pressure sensors, and capacitance measuring devices.

9. The wearable focal vibration device of claim 6, wherein the harness comprises a sleeve that includes a plurality of vibration modules that are configured to provide vibrational therapy to different muscles.

10. The wearable focal vibration device of claim 9, wherein the sleeve comprises a plurality of air bladders, wherein each of the plurality of air bladders corresponds to a different vibrational module and wherein each of the plurality of air bladders is configured to independently adjust the compression applied to each of the plurality of vibration modules.

11. The wearable focal vibration device of claim 10, wherein the sleeve comprises a valve manifold for independently controlling the compression applied to each of the plurality of vibration modules.

12. The wearable focal vibration device of claim 1, further comprising a controller selected from the group consisting of wired and wireless controllers.

13. The wearable focal vibration device of claim 12, wherein the controller is a smart phone that is connected to a clinician's computer through a network.

14. A wearable focal vibration device for providing vibration therapy to a patient, the focal vibration device comprising:
a control module;
a vibration module configured to output a vibration in response to a command signal from the control module, wherein the vibration module comprises:
an electric motor; and
a mass moved by the electric motor;
a vibration sensor configured to output a signal to the control module representative of the vibration measured by the vibration sensor; and
a harness for attaching the focal vibration device to the patient, wherein the harness comprises:
a compression mechanism; and
a compression sensor.

15. The wearable focal vibration device of claim 14, wherein the vibration module is selected from the types of vibration modules consisting of Eccentric Rotating Mass (ERM) vibration motors and Linear Resonant Actuator (LRA) vibration motors.

16. The wearable focal vibration device of claim 15, wherein the vibration sensor is selected from the group consisting of accelerometers, gyroscopes, magnetometers, optical encoders, magnetic encoders, potentiometers, analog-to-digital converters (ADCs), current sensors, photodiodes, phototransistors, photoresistors, cameras, magnetic field sensors, audible sound measuring devices, ultrasound measuring devices, Linear Variable Differential Transformers (LVDT), strain gages, load cells, pressure sensors, capacitance measuring devices, and temperature sensors.

17. The wearable focal vibration device of claim 14, wherein the compression mechanism is selected from the group consisting of inflatable bladders, straps, cords, bands, pumps, motors, servos, solenoids, ratchets, gears, pulleys, wheels, springs, buckles, clips, clasps, and hooks.

18. The wearable focal vibration device of claim 14, wherein the compression sensor is selected from the group consisting of springs, dial indicators, magnets, potentiometers, analog-to-digital converters (ADCs), current sensors, photodiodes, phototransistors, photoresistors, cameras, Linear Variable Differential Transformers (LVDT), strain gages, load cells, pressure sensors, and capacitance measuring devices.

19. A method for using a wearable focal vibration device to apply a vibrational therapy to a patient according to a treatment protocol, the method comprising the steps of:
attaching the wearable focal vibration device to the patient such that a vibration module on the wearable focal vibration device is adjacent a target body part of the patient;
tightening the wearable focal vibration device onto the patient;
activating the vibration module to produce a vibration according to a prescribed vibrational characteristic;
measuring the vibration produced by the vibration module with a vibration sensor in the vibration module; and
adjusting the vibration output by the vibration module in response to measurements taken by the vibration sensor.

20. The method of claim 19, wherein the step of tightening the wearable focal vibration device further comprises:
measuring the level the wearable focal vibration device is tightened to the patient; and
adjusting the level the wearable focal vibration device is tightened to the patient.
